(19) United States
(12) Patent Application Publication
(10) Pub. No.: US 2006/0227075 A1
(43) Pub. Date: Oct. 12, 2006

(54) Plasma display panel and apparatus, and driving device and method of plasma display panel

(76) Inventor: Nam Jin Kim, Seoul (KR)

Correspondence Address: MCKENNA LONG & ALDRIDGE LLP;Song K. Jung, 1900 K Street, N.W., Washington, DC, 20006, US

(21) Appl. No.: 11/328,073

(22) Filed: Jan. 10, 2006

(30) Foreign Application Priority Data
Apr. 7, 2005 (KR) 10-2005-0029171

(51) Int. Cl. G09G 3/28

(52) U.S. Cl. 345/63

(57) ABSTRACT

A plasma display panel, a plasma display apparatus, and a driving device and method of the plasma display panel are provided. The plasma display apparatus which comprises a plasma display panel comprising a scan electrode and a sustain electrode and a sustain pulse controller for setting a number of sustain pulses applied to the scan electrode or the sustain electrode per a unit gray level in sustain period of a lower gray level subfield of a subfield group to be greater than the number of sustain pulses of the other subfield in the frame.

This Nonprovisional application claims priority under 35 U.S.C. §119(a) on Patent Application No. 10-2005-0029171 filed in Korea on Apr. 7, 2005, the entire contents of which are hereby incorporated by reference.

### BACKGROUND OF THE INVENTION

1. Field of the Invention

The present invention relates to a plasma display apparatus, and more particularly, to a plasma display panel, a plasma display apparatus, and a driving device and method of the plasma display panel, for controlling the number or sustain times of sustain pulses applied during a sustain period in a phase alternating line (PAL) driving method.

2. Description of the Background Art

In general, in a plasma display panel, one unit cell is provided at a space between barrier ribs formed between a front panel and a rear panel. Main discharge gas such as neon (Ne), helium (He) or a mixture (He+Ne) of neon and helium and inert gas containing a small amount of xenon (Xe) fills each cell. When a discharge is performed using a high frequency voltage, the inert gas generates vacuum ultraviolet rays and phosphors provided between the barrier ribs are emitted, thereby realizing an image. The plasma display panel is considered as one of the next generation displays due to its slimness and lightweigt.

FIG. 1 illustrates a structure of a conventional plasma display panel.

As shown in FIG. 1, a plasma display panel comprises a front panel 100 and a rear panel 110. The front panel 100 has a plurality of sustain electrode pairs arranged with a scan electrode 102 and a sustain electrode 103 each paired and formed on a front glass 101, which is a display surface for displaying the image thereon. The rear panel 110 has a plurality of address electrodes 113 arranged to intersect with the plurality of sustain electrode pairs on a front glass 111, which is spaced apart in parallel with and attached to the front panel 100.

The front panel 100 comprises the paired scan electrode 102 and the paired sustain electrode 103 for performing a mutual discharge in one pixel and sustaining emission of light, that is, the paired scan electrode 102 and the paired sustain electrode 103 each having a transparent electrode (a) formed of indium-tin-oxide (ITO) and a bus electrode (b) formed of metal. The scan electrode 102 and the sustain electrode 103 are covered with at least one dielectric layer 104, which controls a discharge current and insulates the paired electrodes. A passivation layer 105 is formed of oxide magnesium (MgO) on the dielectric layer 104 to facilitate a discharge condition.

The rear panel 110 comprises stripe-type (or well-type) barrier ribs 112 for forming a plurality of discharge spaces (that is, discharge cells) and arranged in parallel. The rear panel 110 comprises a plurality of address electrodes 113 arranged in parallel with the barrier ribs 112 perform an address discharge and generate the vacuum ultraviolet rays. Red (R), green (G), blue (B) phosphors 114 emit visible rays for displaying the image in the address discharge, and are coated over an upper surface of the rear panel 110. Lower dielectric layer 115 for protecting the address electrode 113 is formed between the address electrode 113 and the phosphor 114.

A method for expressing an image gray level in the plasma display panel is illustrated in FIG. 2.

FIG. 2 illustrates a conventional method for expressing the image gray level in the plasma display panel.

As shown in FIG. 2, one frame is divided into several subfields, each subfield having the different number times of emission. Each subfield is divided into a reset period (RPD) for initializing all cells, an address period (APD) for selecting a discharged cell, and a sustain period (SPD) for expressing the gray level depending on the number times of discharges. For example, when the image is displayed in 256 gray levels, as shown in FIG. 2, a frame period (16.67 ms) corresponding to a 1/60 second is divided into eight subfields (SF1 to SF8), and each of the eight subfields (SF1 to SF8) is divided into the reset period, the address period, and the sustain period.

The reset period and the address period of each subfield are the same at each subfield. The address discharge for selecting the cell to be discharged is generated by a voltage difference between the address electrode and the scan electrode being the transparent electrode. The sustain period is increased in a ratio of 2ⁿ (n=0,1,2,3,4,5,6,7) for each subfield. Since the sustain period is different for each subfield as described above, the sustain period for each subfield (that is, the number times of sustain discharge) is controlled, thereby expressing the image gray level. A driving waveform of the above plasma display panel is described below.

FIG. 3 illustrates a driving waveform based on a driving method of a conventional plasma display panel.

As shown in FIG. 3, the plasma display panel is driven by dividing each subfield into the reset period for initializing all cells, the address period for selecting the cell to be discharged, and the sustain period for sustaining a discharge of the selected cell.

During a setup period of the reset period, a ramp-up waveform is concurrently applied to all of the scan electrodes. The ramp-up waveform generates a weak dark discharge within the discharge cells of a whole screen. The setup discharge causes positive wall charges to be accumulated on the address electrode and the sustain electrode, and negative wall charges to be accumulated on the scan electrode.

During a setdown period, after the ramp-up waveform is supplied, a ramp-down waveform, which falls from a positive voltage lower than a peak voltage of the ramp-up waveform to a specific voltage lower than ground (GND), generates a weak erasure discharge within the cells, thereby sufficiently erasing excessive wall charges from the scan electrode. The setdown discharge causes a sufficient number of wall charges to allow a stable address discharge to uniformly remain within the cells.

During the address period, a negative scan pulse is sequentially applied to the scan electrodes and at the same time, a positive data pulse is synchronized to the scan pulse and applied to the address electrodes. The voltage difference between the scan pulse and the data pulse is added to the wall charge generated in the reset period, thereby generating the address discharge within the cell to which the data pulse is applied. The sufficient number fo wall charges, which enables the discharge when the sustain voltage (Vs) is applied, are generated within the cells selected by the address discharge. During the setdown period and the address period, a positive voltage (Vz) is supplied to the sustain electrode to reduce the voltage difference with the scan electrode and prevent erroneous discharge with the scan electrode.

During the sustain period, the sustain pulse is alternately supplied to the scan electrode and the sustain electrode. At the cell selected through the address discharge, whenever the sustain pulse is applied while the sustain pulse being added to the wall voltage within the cell, a sustain discharge (that is, a display discharge) is generated between the scan electrodes and the sustain electrode.

After the sustain discharge is complete, in the erasure period, a voltage of an erasure ramp waveform (Ramp-ers) having a small pulse width and a voltage level is supplied to the sustain electrode, thereby erasing the remaining wall charges from the cells of the whole screen.

In such a conventional driving waveform, the numbers of sustain pulses per a unit gray level is the same in all subfields.

A description of the number of the sustain pulses in the conventional driving waveform will be made in FIG. 4 below.

FIG. 4 illustrates in more detail the number of the sustain pulses supplied in the sustain period in the driving waveform based on the conventional driving method of the plasma display panel of FIG. 3.

As shown in FIG. 4, the number of sustain pulses per the unit gray level is the same in all subfields in the driving waveform according to the conventional driving method of the plasma display panel.

For example, assuming that a weight added value of 1, that is, a gray level of 1 of ten sustain pulses is embodied in the conventional driving waveform as in FIG. 4, a ratio of a gray level of a first subfield to the number of the sustain pulses is 1 to 10. In other words, the number of sustain pulses supplied per unit gray level is the same for all of the subfields. For example, when 20 sustain pulses are applied to embody a gray level of 2 in a second subfield, 1280 sustain pulses are applied to embody a gray level of 128 even in an eighth subfield.

Such ratios of the gray level to the number of the sustain pulses are the same not only at the first subfield but also in second, third, fourth, fifth, sixth, seventh, and eighth subfields.

In the conventional driving method where the numbers of the sustain pulses per the unit gray level ise the same in all subfields as described above, there is a drawback in that the wall charges are not sufficiently generated in amount within the discharge cell in the reset period at a low gray level subfield having a lower gray level value than other high gray level subfields. Accordingly, there is a drawback in that a subsequent address discharge is will be unstable, and the sustain discharge after the address discharge will be unstable in the low gray level subfield having the lower gray level value.

In the above conventional driving waveform, the lengths of the sustain times of the sustain pulses per unit gray level are the same in all of the subfields.

The length of the sustain time of the sustain pulse in the conventional driving waveform will be described as in FIG. 5 below.

FIG. 5 illustrates in more detail an exemplary sustain time length of the sustain pulse supplied during the sustain period in the driving waveform based on the conventional driving method of the plasma display panel of FIG. 3.

As shown in FIG. 5, in the conventional driving waveform, the lengths of the sustain times, that is, pulse widths of the sustain pulses applied in the sustain periods of all of the subfields are the same. For example, as in FIG. 5, in the sustain periods of all of the subfields, the lengths of the sustain times of the sustain pulses, that is, the widths of the sustain pulses are constantly sustained as “W”.

Unlike the driving waveform of FIG. 5, the length of the sustain time, that is, the pulse width of any one of the sustain pulses of one sustain period can also be increased. Such a driving waveform will be described in FIG. 6 below.

FIG. 6 illustrates in more detail another exemplary sustain time length of the sustain pulse supplied during the sustain period in the driving waveform based on the conventional driving method of the plasma display panel of FIG. 3.

As shown in FIG. 6, in conventional another driving waveform, the length of the sustain time, that is, the pulse width of any one of the sustain pulses applied in the sustain period is longer than those of other sustain pulses. For example, as in FIG. 6, when the length of the sustain time, that is, the pulse width of a first sustain pulse is supplied in the sustain periods is denoted by “W1”, and the length of the sustain time, that is, the pulse width of the subsequent second sustain pulse is denoted by “W2”, the “W1” is larger than the “W2”.

Even though the length of the sustain time, that is, the pulse width of at least any one of the sustain pulses supplied in the sustain period is longer than the sustain time length of other sustain pulses, the lengths of the sustain times of the sustain pulses per the unit gray level are the same in all subfields. In the conventional driving waveform of FIG. 6, the length of the sustain time, that is, the pulse width (W1) of the first sustain pulse is sustained equally in all subfields. Further, the length of the sustain time, that is, the pulse width (W2) of the subsequent second sustain pulse is also sustained equally in all subfields.

There is a drawback in that a discharge is even more unstable at the low gray level subfield, thereby creating a high probability of an unstable subfield address discharge due to the lower gray level value.

In the plasma display panel driven in the above driving method, flicker generally occurs.

Generally, The flicker occurs when an afterglow time of a phosphor is shorter than a vertical frequency (frame frequency) of an image signal. For example, when the vertical frequency is 60 Hz, an image of one frame is displayed at 16.67 m/sec and the phosphor is faster in its response speed than the 16.67 m/sec, thereby generating screen flicker.

In particular, a phase alternating line (PAL) method has a drawback in that the vertical frequency is a shorter frequency of 50 Hz, thereby causing the generation of a significant a mount of flicker.

In the conventional PAL method, attempts have been made to reduce the generation of flicker by arranging the subfields within one frame using a plurality of steps.

The subfield arrangement of the PAL method will be described as in FIG. 7 below.

FIG. 7 illustrates the subfield arrangement for realizing the image of the plasma display panel in the conventional PAL method.

Referring to FIG. 7, in the conventional PAL method, the subfields having different weight added values are divided and arranged in a format of a plurality of groups, preferably, in a format of two groups within one frame. For example, as in FIG. 7, a first subfield group comprises a subfield having a weight added value, that is, a gray level value of 1, a subfield having a weight added value of 8, a subfield having a weight added value of 16, a subfield having a weight added value of 32, and a subfield having a weight added value of 64.

A second subfield group comprises a subfield having a weight added value of 2, a subfield having a weight added value of 4, two subfields having weight added values of 8, a subfield having a weight added value of 16, a subfield having a weight added value of 32, and a subfield having a weight added value of 64.

A sum of the weight added values of the arranged subfields within one frame, that is, a sum of the gray level values is 1+2+4+8+(8+8)+(16+16)+(32+32)+(64+64), that is, 255. As a result, 256 gray levels can be embodied.

In the conventional PAL method for driving the plasma display panel by arranging the subfields in one frame through the two steps, there is an effect of reducing the generation of flicker, but there is a drawback of increasing the number of the subfields having the lower gray level value, that is, the lower gray level value within one frame.

In other words, assuming that the subfields having the lower weight added values, that is, the lower gray level values are distinguished as the first, second, third and fourth subfields having the gray level values of 1, 2, 4, and 8 in a general method where the subfields are arranged through one step in one frame as in FIG. 2, the subfields having the lower weight added values, that is, the lower gray level values are the first and second subfields in the first subfield group, and are the first, second, third and fourth subfields in the second subfield group in the PAL method where the subfields are arranged through the two steps in one frame.

Accordingly, in comparison with the general method where the subfields are arranged through one step in one frame, the PAL method has a drawback in that the low gray level subfields having the lower weight added values, that is, the lower gray level values increase in number, thereby causing a phenomenon where a subsequent sustain discharge becomes unstable or is not generated at all due to an unstable address discharge.

### SUMMARY OF THE INVENTION

Accordingly, an object of the present invention is to solve at least the problems and disadvantages of the background art.

An object of the present invention is to provide a plasma display panel, a plasma display apparatus, and a driving device and method of the plasma display panel, for reducing the generation of flicker and controlling the number or sustain times of sustain pulses, thereby improving a discharge characteristic.

To achieve these and other advantages and in accordance with the purpose of the present invention, as embodied and broadly described, there is provided a plasma display apparatus comprising: a plasma display panel comprising a scan electrode and a sustain electrode; and a sustain pulse controller for setting a number of sustain pulses applied to the scan electrode or the sustain electrode per a unit gray level in sustain period of a lower gray level subfield of a subfield group to be greater than the number of sustain pulses of the other subfield in the frame.

The present invention reduces the generation of flicker by differing a gray level weight added value of a subfield in a PAL driving method.

Further, the present invention controlls the number or sustain times of the sustain pulses, thereby improving the discharge characteristic.

### BRIEF DESCRIPTION OF THE DRAWINGS

The invention will be described in detail with reference to the following drawings in which like numerals refer to like elements.

FIG. 1 illustrates a structure of a conventional plasma display panel;

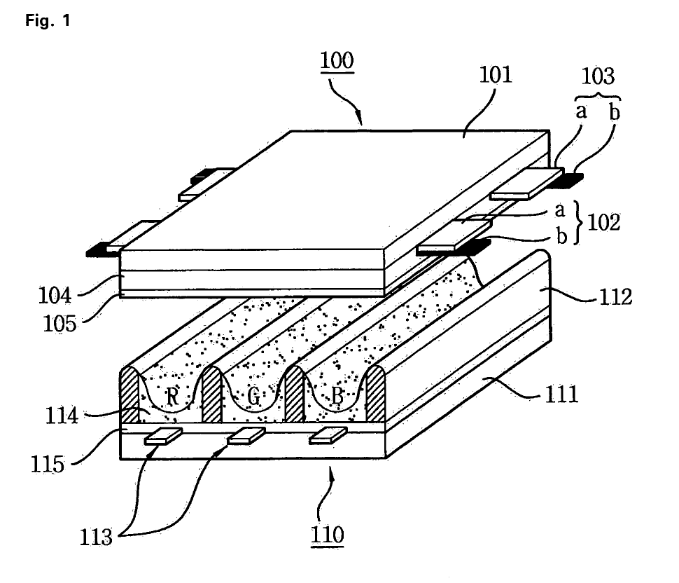

FIG. 2 illustrates a conventional method for realizing an image gray level of a plasma display panel;

FIG. 3 illustrates an example of a driving waveform based on a conventional driving method of a plasma display panel;

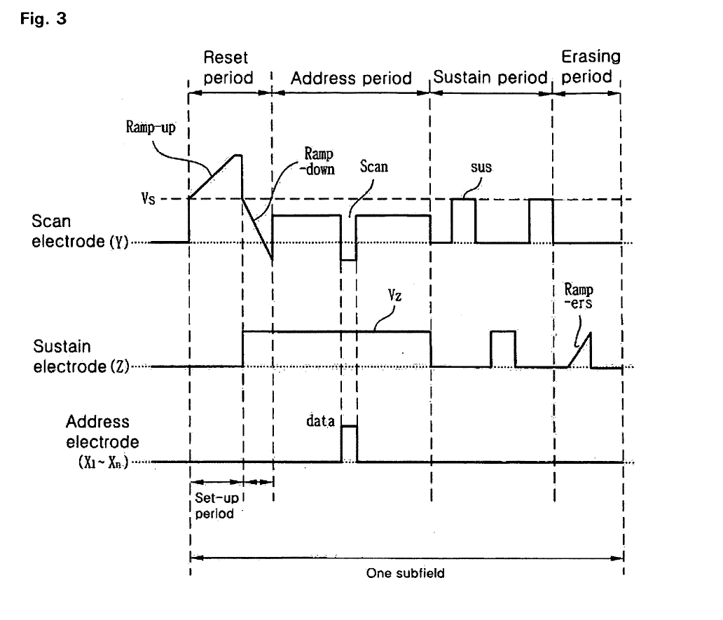

FIG. 4 illustrates in more detail the number of sustain pulses supplied during a sustain period in the driving waveform based on the conventional driving method of the plasma display panel of FIG. 3;

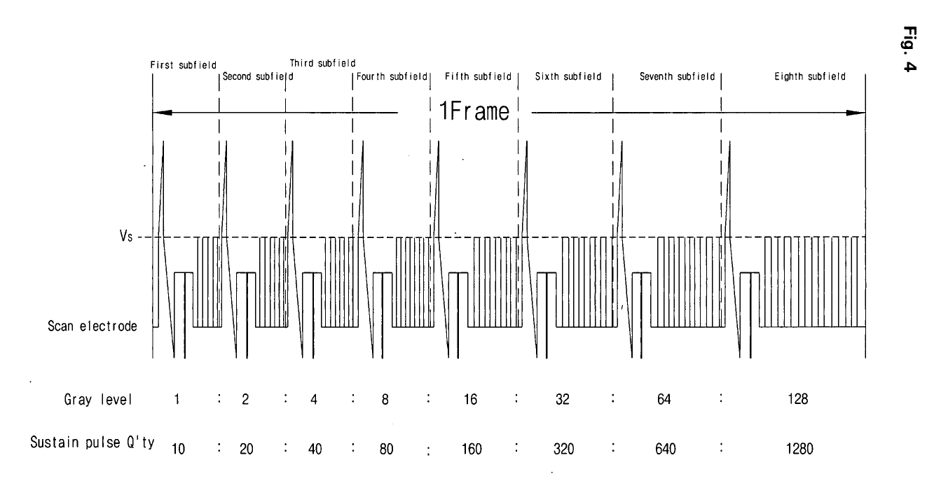

FIG. 5 illustrates in more detail an exemplary sustain time length of a sustain pulse supplied during a sustain period in the driving waveform based on the conventional driving method of the plasma display panel of FIG. 3;

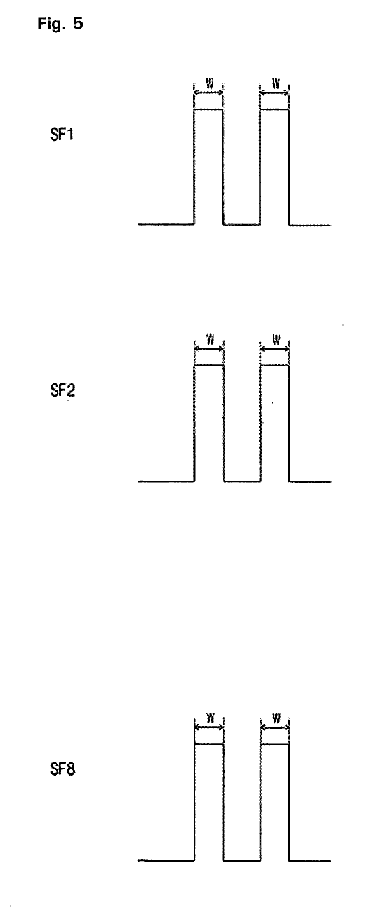

FIG. 6 illustrates in more detail another exemplary sustain time length of a sustain pulse supplied during a sustain period in the driving waveform based on the conventional driving method of the plasma display panel of FIG. 3;

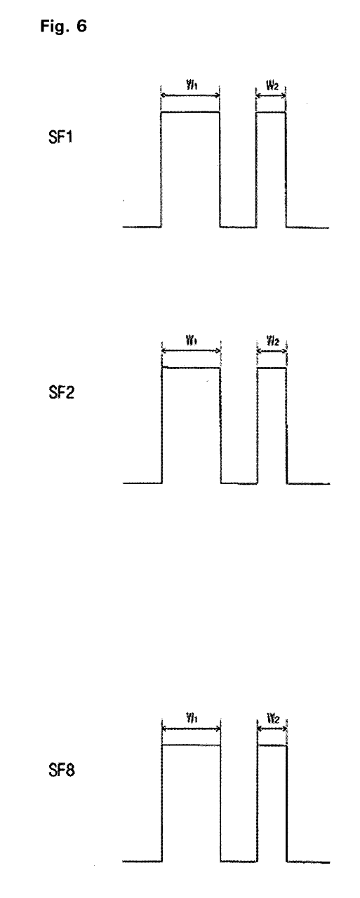

FIG. 7 illustrates a subfield arrangement for realizing an image of a plasma display panel in a conventional PAL method;

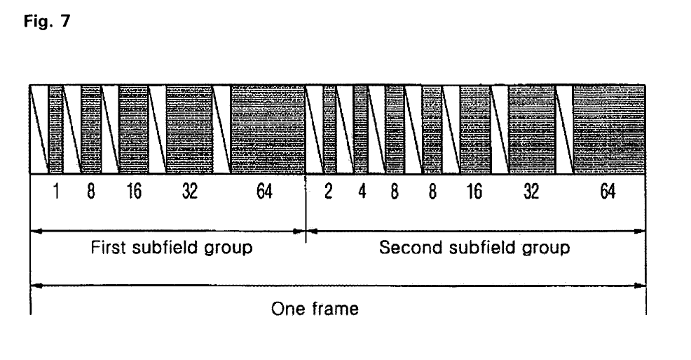

FIG. 8 illustrates a plasma display apparatus according to the present invention;

FIGS. 9A and 9B illustrate an example of dividing one frame into a plurality of subfield groups;

FIG. 10 illustrates a driving method of a plasma display panel according to the first embodiment of the present invention;

FIG. 11 illustrates an example of a method of setting a low gray level subfield in a driving method of a plasma display panel according to the first embodiment of the present invention;

FIG. 12 illustrates an arrangement of subfields within one subfield group in a driving method of a plasma display panel according to the first embodiment of the present invention;

FIGS. 13A and 13B illustrate another example of dividing one frame into a plurality of subfield groups;

FIG. 14 illustrates an example of a driving waveform having a subfield arrangement sequence of FIGS. 13A and 13B;

FIGS. 15A and 15B illustrate a further another example of dividing one frame into a plurality of subfield groups;

FIGS. 16A and 16B illustrate a still further another example of dividing one frame into a plurality of subfield groups;

FIG. 17 illustrates a driving method of a plasma display panel according to the second embodiment of the present invention;

FIG. 18 illustrates an example of a setting method of a sustain time length of a sustain pulse of a low gray level subfield in a driving method of a plasma display panel according to the second embodiment of the present invention;

FIG. 19 illustrates another example of a setting method of a sustain time length of a sustain pulse of a low gray level subfield in a driving method of a plasma display panel according to the second embodiment of the present invention;

FIG. 20 illustrates an arrangement of subfields within one subfield group in a driving method of a plasma display panel according to the second embodiment of the present invention; and

FIG. 21 illustrates another arrangement of subfields within one subfield group in a driving method of a plasma display panel according to the second embodiment of the present invention.

### DETAILED DESCRIPTION OF PREFERRED EMBODIMENTS

Preferred embodiments of the present invention will be described in a more detailed manner with reference to the drawings.

The inventive plasma display apparatus displays an image in a frame having a plurality of subfield groups, the plasma display apparatus comprising: a plasma display panel comprising a scan electrode and a sustain electrode; and a sustain pulse controller for setting a number of sustain pulses applied to the scan electrode or the sustain electrode per a unit gray level in sustain period of a lower gray level subfield of a subfield group to be greater than the number of sustain pulses of the other subfield in the frame.

The inventive plasma display apparatus displays an image in a frame having a plurality of subfield groups, the plasma display apparatus comprising: a plasma display panel comprising a scan electrode and a sustain electrode; and a sustain pulse controller for setting a width of sustain pulses applied to the scan electrode or the sustain electrode per a unit gray level in sustain period of a lower gray level subfield of a subfield group to be greater than the width of sustain pulses of the other subfield in the frame.

The subfield group has at least two low gray level subfields and the sustain pulse controller sets the numbers of the sustain pulses per the unit gray level applied in sustain periods of any one low gray level subfields of the subfield group to be different from other low gray level subfields.

The sustain pulse controller allows the number of the sustain pulses per the unit gray level supplied in the sustain period of a first low gray level subfield having a lower gray level value than a second low gray level subfield among two different low gray level subfields to be greater than the number of the sustain pulses per the unit gray level of the second low gray level subfield, in one subfield group.

The sustain pulse controller allows the number of the sustain pulses per the unit gray level supplied in the sustain period of a first low gray level subfield having a smaller gray level value than a second low gray level subfield among two different low gray level subfields to be greater than the number of the sustain pulses per the unit gray level of the second low gray level subfield, in one subfield group.

The low gray level subfields are comprised of a subfield having the least number of the sustain pulses up to a fourth subfield, in a sequence where the number of the sustain pulses supplied in the sustain period is small, in one subfield group.

The low gray level subfield is a subfield having the least number of the sustain pulses supplied in the sustain period, in one subfield group.

The low gray level subfield is a subfield having a half or less of a total of the most number of the sustain pulses supplied in the sustain period in one frame.

The low gray level subfield is a subfield having 20% or less of a total number of the sustain pulses supplied in one frame.

The subfields are irregularly arranged in a sequence depending on a magnitude of a gray level value, in at least one subfield group.

An idle period having a predetermined length is provided between the frames, and the subfield groups of the frame are continued in the same frame.

A first idle period having a predetermined length is provided between the frames, and a second idle period having a predetermined length is additionally provided between the subfield groups in the same frame.

The first and second idle periods are the same in length.

The plurality of subfield groups has a plurality of subfields, respectively, and the subfields are arranged in a sequence of increasing the magnitude of the gray level value, in each of the plurality of subfield groups.

The plurality of subfield groups has a plurality of subfields, respectively, and the subfields of each of the plurality of subfield groups are arranged in a sequence of decreasing the magnitude of the gray level value.

The frame is divided into two subfield groups, and the two subfield groups have a plurality of subfields, respectively, and the subfields are arranged in a sequence depending on magnitudes of gray level values different from one another, in each of the two subfield groups.

The subfields are arranged in a sequence of increasing the magnitude of the gray level value, in any one of the two subfield groups.

The subfields are arranged in a sequence of decreasing the magnitude of the gray level value in any one of the two subfield groups.

The subfields are arranged in a sequence of decreasing the magnitude of the gray level value in any one of the two subfield groups, and the subfields are arranged in a sequence of increasing the magnitude of the gray level value in the other one of the two subfield groups.

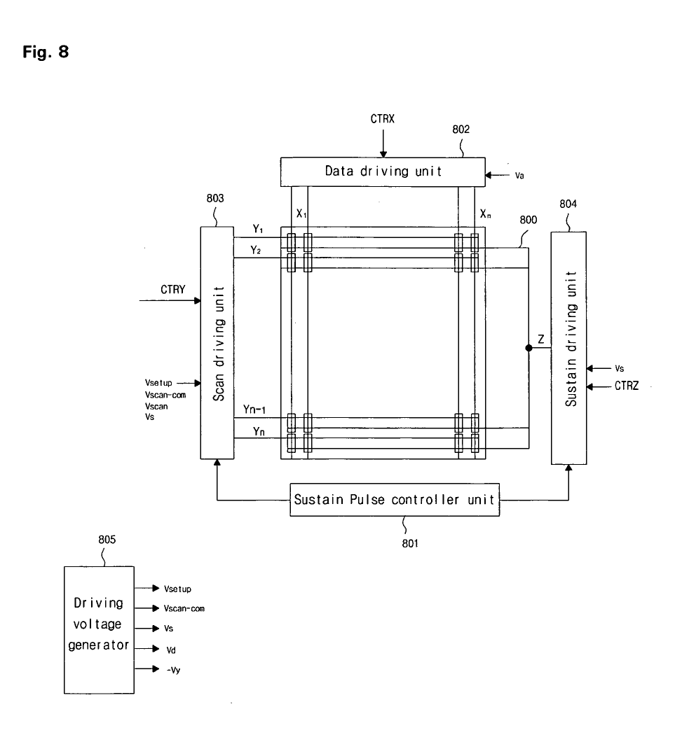

FIG. 8 illustrates a plasma display apparatus according to the present invention.

As shown in FIG. 8, the inventive plasma display apparatus comprises a plasma display panel 800; and a driving device applying a driving pulse and comprising a data driver 802, a scan driver 803, a sustain driver 804, and a sustain pulse controller 801.

For example, as shown in FIG. 8, the inventive plasma display apparatus comprises the plasma display panel 800 for displaying an image constituted of a frame by combining at least two subfields where a driving pulse is applied to address electrodes (X₁ to Xₘ), scan electrodes (Y₁ to Yₙ), and sustain electrodes (Z) in a reset period, an address period, and a sustain period; the data driver 802 for supplying data to the address electrodes (X₁ to Xₘ) provided at the plasma display panel 800; the scan driver 803 for driving the scan electrodes (Y₁ to Yₙ); the sustain driver 804 for driving the sustain electrodes (Z) being common electrodes; the sustain pulse controller 801 for, when the plasma display panel 801 is driven, controlling the scan driver 803 and the sustain driver 804 to control sustain time lengths, that is, pulse widths or the number of the sustain pulses; and a driving voltage generator 805 for supplying a necessary driving voltage to each of the drivers 802, 803 and 804.

The inventive plasma display apparatus displays the image constituted of the frame by combining at least two subfields for applying the driving pulse to the address electrodes (X₁ to Xₘ), the scan electrodes (Y₁ to Yₙ), and the sustain electrode (Z) in the reset period, the address period, and the sustain period, and divides the frame into a plurality of subfield groups each having at least one subfield, and more increases the sustain time lengths, that is, the pulse widths and the number of the sustain pulses per a unit gray level supplied in the sustain period of a low gray level subfield than at other subfields, in at least one of the subfield groups.

In the plasma display panel 800, a front panel (not shown) and a rear panel (not shown) are attached to each other at a predetermined distance therebetween. At the front panel or the rear panel, a plurality of electrodes, for example, the scan electrodes (Y₁ to Yₙ) and the sustain electrode (Z) are paired, and the address electrodes (X₁ to Xₘ) are formed to intersect with the scan electrodes (Y₁ to Yₙ) and the sustain electrode (Z).

The data driver 802 receives data, which is inverse gamma corrected and error diffused in an inverse gamma correction circuit and error diffusion circuit (not shown), and then mapped to each subfield in a subfield mapping circuit. In the data driver 802, data is sampled and latched in response to a data timing control signal (CTRX) from a timing controller (not shown) and then, is supplied to the address electrodes (X₁ to Xₘ).

Under the control of the sustain pulse controller 801, the scan driver 803 supplies the sustain pulse where the number per the unit gray level or the sustain time length, that is, the pulse width is controlled depending on a gray level value of the subfield during the sustain period. The scan driver 803 sequentially supplies a scan pulse (Sp) of a scan voltage (−Vy) to the scan electrodes (Y₁ to Yₙ) during the address period, and supplies the sustain pulse (sus) to the scan electrodes (Y₁ to Yₙ) during the sustain period.

Under the control of the timing controller (not shown), the sustain driver 804 supplies a predetermined bias voltage to the sustain electrode (Z) during a ramp-down waveform generation period and the address period, and operates alternately with the scan driver 803 during the sustain period to supply the sustain pulse (sus) where the number per unit gray level or the sustain time length, that is, the pulse width is controlled depending on the gray level value of the subfield, to the sustain electrode (Z).

The sustain pulse controller 801 generates a predetermined control signal for controlling operation timing and synchronization of the scan driver 803 or the sustain driver 804 in the reset period, and supplies the generated timing control signal to the scan driver 803 or the sustain driver 804, thereby controlling the scan driver 803 or the sustain driver 804. Specifically, the sustain pulse controller 801 supplies the control signal to the scan driver 803 and the sustain driver 804 to control the number of sustain pulses and length of the sustain times, that is, the pulse widths of the sustain pulses per the unit gray level supplied in the sustain period of the low gray level subfield in at least one of the subfield groups.

The data control signal (CTRX) comprises a sampling clock for sampling data, a latch control signal, and a switch control signal for controlling an on/off time of an energy recovery circuit and a driving switch element. A scan control signal (CTRY) comprises a switch control signal for controlling an on/off time of an energy recovery circuit and a driving switch element installed at the scan driver 803, and a sustain control signal (CTRZ) comprises a switch control signal for controlling an on/off time of an energy recovery circuit and a driving switch element installed at the sustain driver 804.

The driving voltage generator 805 generates a setup voltage (Vsetup), a scan common voltage (Vscan-com), a scan voltage (−Vy), a sustain voltage (Vs), and a data voltage (Vd). The driving voltages can be varied depending on the composition of a discharge gas or the structure of the discharge cell.

The inventive plasma display apparatus of FIG. 8 will be more apparent in a driving method below.

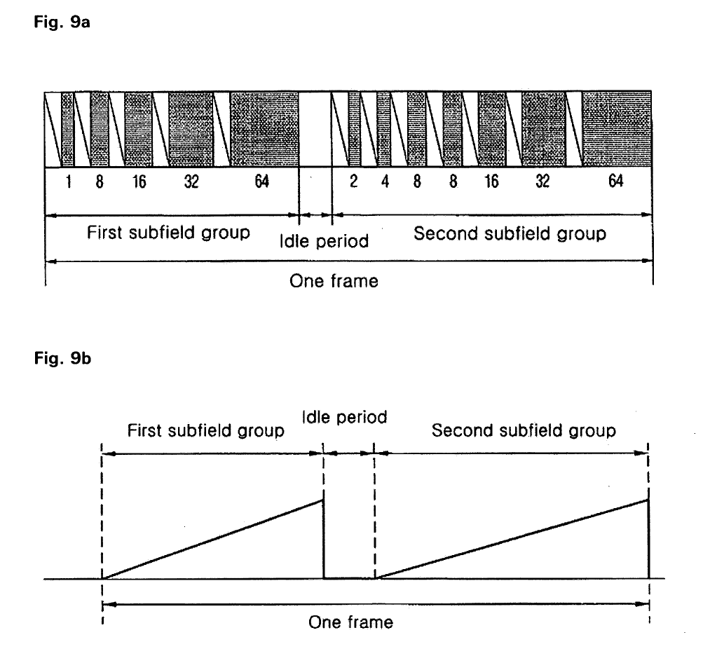

In the driving method according to the first embodiment of the present invention performed by the plasma display apparatus, one frame is divided into the plurality of subfield groups each having at least one subfield, and the sustain time lengths, that is, the pulse widths and the number of sustain pulses per unit gray level supplied in the sustain period of the low gray level subfield are more than other subfields in at least one of the subfield groups. An example of arranging the subfields through a plurality of steps within one frame will be described as in FIGS. 9A and 9B below.

FIGS. 9A and 9B illustrate an example of dividing one frame into the plurality of subfield groups.

Referring to FIGS. 9A and 9B, in the inventive driving method of the plasma display panel, one frame is divided into the plurality of subfield groups, for example, as shown in FIG. 9A, into two subfield groups, that is, a first subfield group and a second subfield group and the subfields are arranged, so that the subfield arrangement is performed through two steps.

An idle period having a predetermined length is comprised between the first subfield group and the second subfield group as shown in FIG. 9B. That is, one idle period is comprised between two subfield groups.

The subfields are arranged in a sequence of increasing magnitude of weight added value, that is, a magnitude of the gray level value, in each group, that is, in the first subfield group and the second subfield group. In other words, a subfield having the lowest weight added value, that is, the lowest gray level value is disposed at an initial position of each subfield group, and a subfield having a higher weight added value is disposed at a later position. For example, as in FIG. 9A, the first subfield group comprises a subfield having a weight added value of 1, that is, a gray level value of 1, a subfield having a weight added value of 8, a subfield having a weight added value of 16, a subfield having a weight added value of 32, and a subfield having a weight added value of 64, in order.

The second subfield group comprises a subfield having a weight added value of 2, that is, a gray level value of 2, a subfield having a weight added value of 4, two subfields having weight added values of 8, a subfield having a weight added value of 16, a subfield having a weight added value of 32, and a subfield having a weight added value of 64, in order.

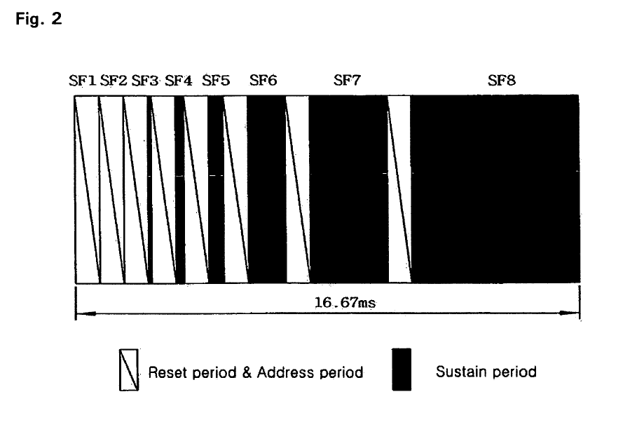

In one frame having the above arrangement, a sum of the weight added values of the subfields is 1+2+4+8+(8+8)+(16+16)+(32+32)+(64+64), that is, 255. As a result, 256 gray levels, such as the frame of FIG. 2 where the subfields having the weight added values of 1, 2, 4, 8, 16, 32, 64, and 128 are arranged in order, is realized. The first subfield group for embodying 121 gray levels and the second subfield group for embodying 135 gray levels can be provided, thereby providing an effect of embodying two frames for realizing the 121 gray levels and the 135 gray levels, using one frame of the 256 gray levels. Accordingly, the frame is increased by two fold thereby reducing flicker. The concept of weight added value of the subfield within one frame and the concept of the idle period are shown in FIG. 9B.

Referring to FIG. 9B, two subfield groups, that is, the first subfield group and the second subfield group are provided within one frame, and the idle period is provided between the subfield groups. Attention should be paid to the triangle shape that represents the weight added values of the subfields comprised in each subfield group. This means that the subfields are arranged in a sequence of increasing magnitude of the weight added value, that is, the gray level value within each subfield group.

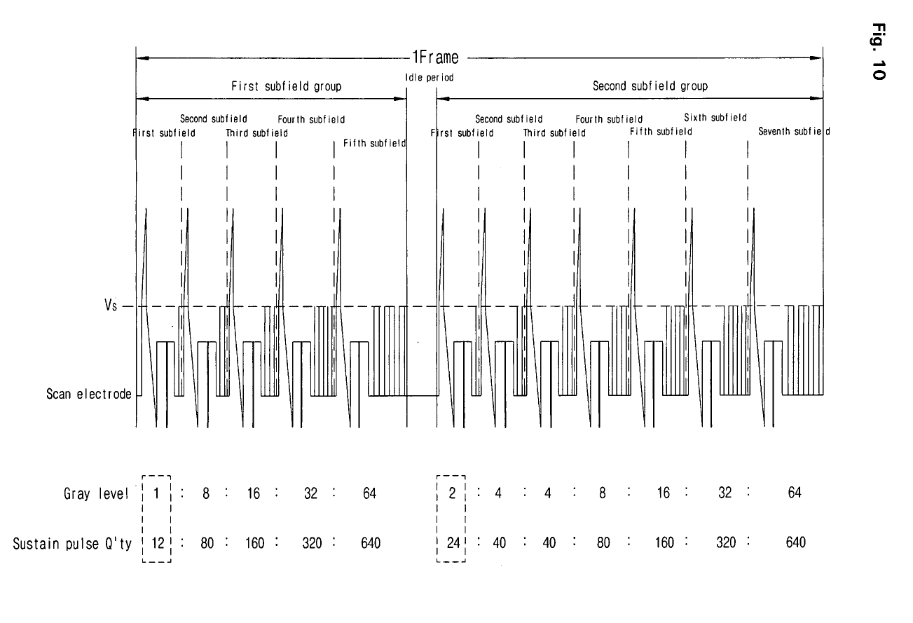

In the driving method where one frame is divided into the plurality of subfield groups as aforementioned, the number per unit gray level of the sustain pulses supplied in the sustain period of the low gray level subfield in at least one of the subfield groups is controlled. An example of the driving method will be described with reference to FIG. 10.

FIG. 10 illustrates the driving method of the plasma display panel according to the first embodiment of the present invention.

As shown in FIG. 10, in the driving method of the plasma display panel comprising the scan electrode, the sustain electrode, and a plurality of address electrodes intersecting with the scan electrode and the sustain electrode, one frame is divided into the plurality of the subfield groups each comprising at least one subfield, and the number per unit gray level of the sustain pulses supplied in the sustain period at the low gray level subfield is more than other subfields in at least one of the above divided subfield groups.

For example, in a case where one frame is divided into two subfield groups, that is, into the first subfield group and the second subfield group as shown in FIG. 10, the number per unit gray level of the sustain pulses supplied in the sustain period of the first subfields for embodying the lowest gray level due to the lowest weight added value in each subfield group, that is, at the first subfield of the first subfield group and the first subfield of the second subfield group gets is more than the number per unit gray level of the sustain pulses at other subfields, that is, the second, third, fourth, and fifth subfields of the first subfield group and the second, third, fourth, fifth, sixth, and seventh subfields of the second subfield group. In other words, the sustain pulses used to embody the gray level of 1 at the first subfield of the first subfield group are 12 in number, and the sustain pulses used to embody the gray level of 1 at other subfields of the first subfield group are 10 in number. Further, the sustain pulses used to embody the gray level of 1 at the first subfield of the second subfield group are 12 in number (this is because 24 sustain pulses are used to embody the gray level of 2), and the sustain pulses used to embody the gray level of 1 at other subfields of the second subfield group are 10 in number.

In FIG. 10, the number per the unit gray level of the sustain pulses of the low gray level subfield in all subfield groups of one frame, that is, in all of the first and second subfield groups is more than at other subfields. The number per the unit gray level of the sustain pulses can be also more than at other subfields only in any selected one of the plurality of subfield groups, for example, only in any one of the first and second subfield groups of FIG. 10.

The following is the reason why the number per the unit gray level of the sustain pulses supplied in the sustain period at the low gray level subfield is more than at other subfields as described above.

In the divided plurality of subfield groups of one frame, the probability of generanting an unstable address discharge at the low gray level subfield for embodying the low gray level due to the lower weight added value is more than at other high gray level subfields. Accordingly, when the number per the unit gray level of the sustain pulses supplied in the sustain period is too small at the low gray level subfield, wall charges within the discharge cell are not sufficiently generated due to the unstable address discharge, thereby destabilizing the subsequent sustain discharge.

The low gray level subfield destabilizing of discharges occurs more frequently that is, a greater number of unstable discharges, when using the PAL driving method of dividing one frame into the plurality of subfield groups. For example, in a case where a subfield having a weight added value of 10 or less, that is, a gray level value of 10 or less is set as the low gray level subfield, the low gray level subfield comprises a first subfield having a gray level of 1, a second subfield having a gray level of 2, a third subfield having a gray level of 4, and a fourth subfield having a gray level of 8, that is, a total of four low gray level subfields in a conventional driving method of FIG. 2, whereas the low gray level subfield having the weight added value of 10 or less, that is, the gray level value of 10 or less comprises a first subfield having a gray level of 1 and a second subfield having a gray level of 8 in the first subfield group, and a first subfield having a gray level of 2, a second subfield having a gray level of 4, a third subfield having a gray level of 8, and a fourth subfield having a gray level of 8 in the second subfield group in the driving method of FIG. 10. In other words, in the PAL method, the number of low gray level subfields increases.

Accordingly, in the PAL method where the low gray level subfields are more provided, the number per the unit gray level of the sustain pulses supplied in the sustain period of the low gray level subfield for embodying the low gray level due to the low weight added value is more than at other subfields, thereby suppressing generation of the flicker while reducing the instability of the sustain discharges.

The low gray level subfield can depend on the number of the sustain pulses supplied in the sustain period. For example, it is preferable that the low gray level subfield is a subfield having a number of sustain pulses that is 50% or less than the largest total number of the sustain pulses supplied in the sustain period within one frame. For example, assuming that the subfield having the largest number of sustain pulses among the subfields comprised within one frame comprises a total of 1000 sustain pulses, a subfield comprising 500 or less of the sustain pulses is set as the low gray level subfield.

It is also possible to set a subfield to have a number of sustain pulses that is, 20% or less than the total number of the supplied sustain pulses of one frame, as the low gray level subfield. For example, assuming that the sustain pulses generated within one frame are 2000 in number, a subfield having 400 or less supplied sustain pulses is set as the low gray level subfield.

Preferably, the low gray level subfield is a subfield having the least number of sustain pulses within one subfield group.

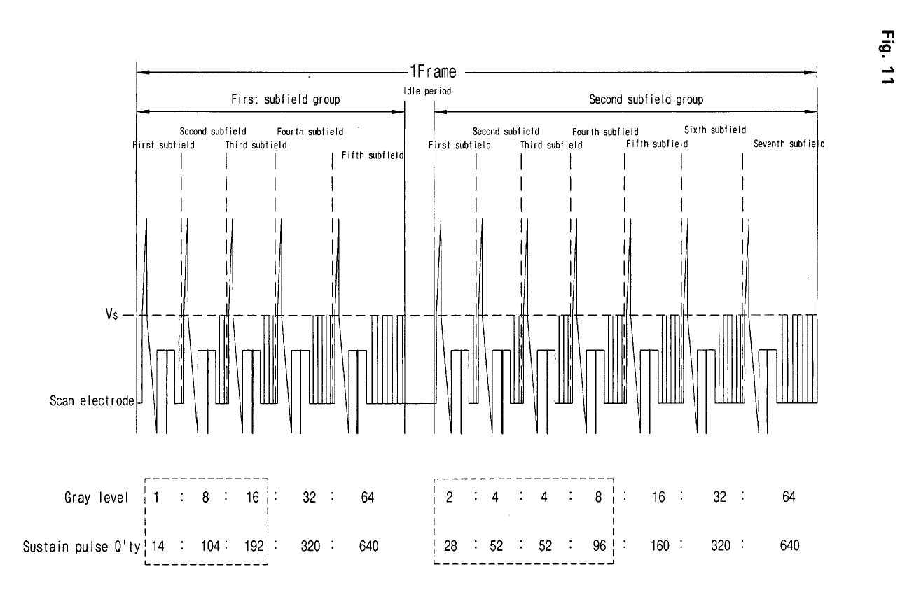

A plurality of the low gray level subfields can be also set in a sequence where the number of the sustain pulses is small, within one frame. An example of setting the low gray level subfield will be described as in FIG. 11 below.

FIG. 11 illustrates an example of a method for setting the low gray level subfield in the driving method of the plasma display panel according to the first embodiment of the present invention.

As shown in FIG. 11, the plurality of subfields is set as the low gray level subfield within one subfield group. The low gray level subfield is set on the basis of a sequence where the number of the sustain pulses is less, and the subfield having the least number of the sustain pulses to the fourth subfield are set as the low gray level subfields. For example, assuming that a total of seven subfields constitutes one subfield group, that is, the second subfield group as shown in FIG. 10, the first subfield for embodying the lowest gray level, that is, the lowest weight added value due to the least number of the sustain pulses, subsequent second, third, and fourth subfields are set as the low gray level subfields.

As described above, the number per unit gray level of the sustain pulses at the low gray level subfield is more than other subfields. In other words, as shown in FIG. 11, the number per unit gray level of the sustain pulses supplied in the sustain period of the first, second, third, and fourth subfields that are set as the low gray level subfields is more than other subfields, that is, the number of the sustain pulses for embodying one gray level is set to exceed 10.

In a case where the plurality of low gray level subfields is comprised within one subfield group as described above, the number per unit gray level of the sustain pulses can be varied even between the low gray level subfields. For example, at the first subfield being the low gray level subfield comprised within the second subfield group as in FIG. 11, the number per unit gray level of the sustain pulses is 14, that is, the number of the sustain pulses used to embody one gray level is 14 (this is because 28 sustain pulses are used to embody two gray levels), and at the second subfield being another low gray level subfield, the number per the unit gray level of the sustain pulses is 13, that is, the number of the sustain pulses used to embody one gray level is 13 (this is because 52 sustain pulses are used to embody four gray levels). As in the case of the second subfield group of FIG. 11, the number per unit gray level of the sustain pulses of at least one selection low gray level subfield of one subfield group can be also different from at other low gray level subfields. Or, as in the case of the first subfield group of FIG. 11, the number per unit gray level of each of the low gray level subfields can be different from one another in one subfield group. In other words, the sustain pulses per the unit gray level are 14 in number at the first subfield being the low gray level subfield of the first subfield group of FIG. 11, and the sustain pulses are 13 in number at the second subfield being another low gray level subfield, and the sustain pulses are 12 in number at the third subfield being a further another low gray level subfield. As such, in case where the low gray level subfields of one subfield group have the number of the sustain pulses per the unit gray level having at least one different sustain pulse, the number per the unit gray level of the sustain pulses is determined depending on a magnitude of the gray level value of a corresponding subfield within the subfield group. For example, in case where two low gray level subfields, that is, the first and second low gray level subfields are selected from one subfield group, the number per the unit gray level of the sustain pulses of the first or second low gray level subfield having a lower gray level value is more than at the first or second low gray level subfield having a greater gray level value. Describing a case of the first subfield group of FIG. 11 as one example, the first and second subfields have the different numbers per the unit gray level of the sustain pulses. The number (14) per the unit gray level of the sustain pulses of the first subfield having the lower gray level value is more than the number (13) per the unit gray level of the sustain pulses of the second subfield.

It is also possible that even though the plurality of low gray level subfields is provided in one subfield group, the numbers of the sustain pulses per the unit gray level supplied in the sustain periods of the low gray level subfields are all the same. Describing a case of the first subfield of FIG. 11 as one example, the number (14) per the unit gray level of the sustain pulses of the first subfield being the low gray level subfield is different from the number (12) per the unit gray level of the sustain pulses of the second subfield being the low gray level subfield, and the number (13) per the unit gray level of the sustain pulses of the third subfield being the low gray level subfield. However, unlike the example of the 1^{st} subfield of FIG. 11, the numbers per the unit gray level of the sustain pulses of the first, second, and third subfields being the low gray level subfields of the first subfield group are all the same as 12.

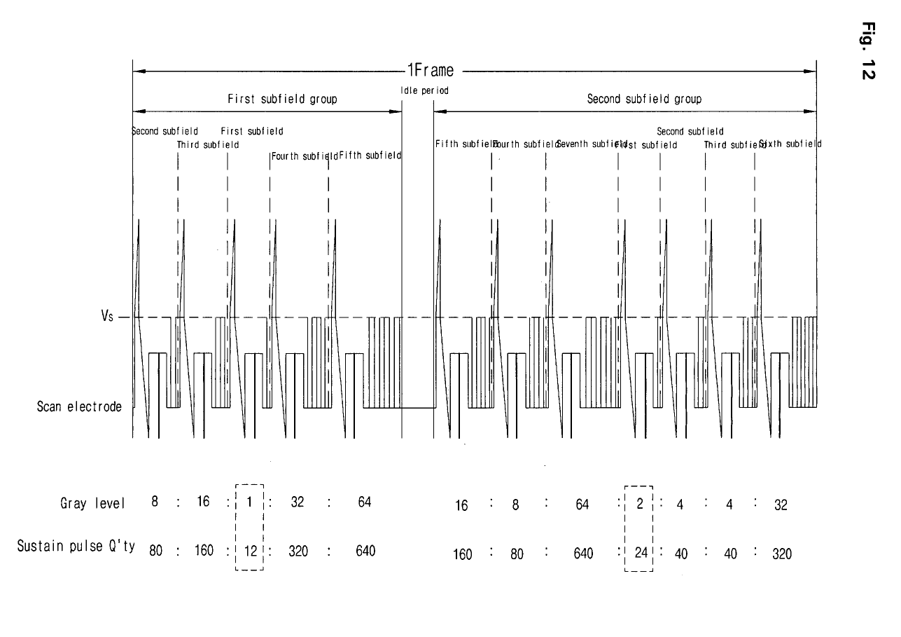

In the above description, described is only one example where the subfields are regularly arranged, in a sequence depending on the magnitude of the weight added value, that is, the magnitude of the gray level value, in one subfield group. The subfields can also be irregularly arranged in one subfield group. An example of such a driving method will be described as in FIG. 12 below.

FIG. 12 illustrates an arrangement of the subfields within one subfield group in the driving method of the plasma display panel according to the first embodiment of the present invention.

As shown in FIG. 12, the subfields are not arranged in a sequence depending on the magnitude of the weight added value, that is, the magnitude of the gray level value, in at least one subfield group, but are randomly arranged irrespective of the magnitude of the gray level value. Even in the subfield group having the random subfield arrangement, the number (12) per the unit gray level of the sustain pulses supplied in the sustain period at a third numbered subfield being the low gray level subfield having the lower weight added value in the first subfield group, that is, at the first subfield is more than the number (10) per the unit gray level of the sustain pulses of other subfields, and the number (12) per the unit gray level of the sustain pulses supplied in the sustain period at a fourth numbered subfield of even the second subfield group, that is, at the first subfield is more than the number (10) per the unit gray level of the sustain pulses of the other subfields.

In comparison with FIG. 10 based on the assumption that the subfield arrangement is based on a sequence of the first, second, third, fourth, and fifth subfields in the first subfield group, and a sequence of the first, second, third, fourth, fifth, sixth, and seventh subfields in the second subfield group, the subfield arrangement of FIG. 12 is based on a sequence of second, third, first, fourth, and fifth subfields in the first subfield group, and a sequence of fifth, fourth, seventh, first, second, third, and sixth subfields in the second subfield group. In FIG. 12, the subfields are randomly arranged irrespective of the magnitude of the weight added value, that is, the magnitude of the gray level value in one subfield group, However, unlike the arrangement FIG. 12, a high gray level subfield having a higher weight added value, that is, a higher gray level value, and the low gray level subfield having the lower weight added value, that is, the lower gray level value can also be alternately arranged in one subfield group. The arrangement sequence of the subfields does not limit the present invention, but even though the subfield group has any subfield arrangement, it is most important that the number per the unit gray level of the sustain pulses supplied in the sustain period of the low gray level subfield among the subfields of the subfield group is more than other subfields.

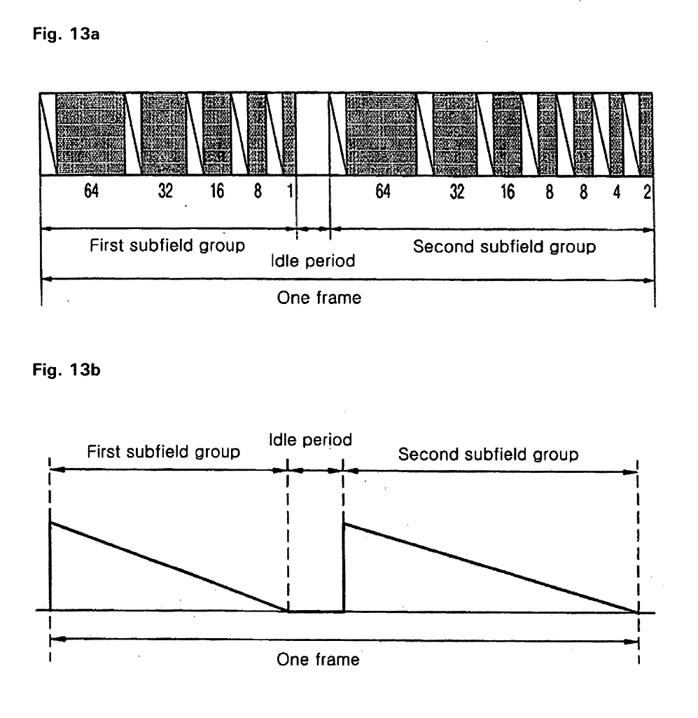

The above description is based on a subfield arrangement being a sequence of increasing the weight added value, that is, the gray level value in one subfield group. However it is also possible to arrange the subfields in a sequence of decreasing gray level value in at least one subfield group. This will be described with reference to FIGS. 13A and 13B.

FIGS. 13A and 13B illustrate another example of dividing one frame into the plurality of subfield groups.

Referring to FIGS. 13A and 13B, one frame is divided into the plurality of subfields, and the subfields are arranged in a sequence of decreasing the magnitude of the weight added value, that is, the magnitude of the gray-level value in at least any one subfield group.

For example, as shown in FIG. 13A, in case where one frame is divided into two subfield groups, the subfields are arranged in a sequence of decreasing the magnitude of the weight added value, that is, the magnitude of the gray level value in each group, that is, in the first subfield group and the second subfield group. In other words, the subfield for embodying the highest gray level owing to the highest weight added value of the subfield is disposed at an initial position of the each subfield group, that is, at the first subfield group or the second subfield group, and the subfield having the lower weight added value, that is, the lower gray level is disposed at a later position. For example, the first subfield group comprises the subfield having the weight added value of 64, the subfield having the weight added value of 32, the subfield having the weight added value of 16, the subfield having the weight added value of 8, and the subfield having the weight added value of 1, in order.

The second subfield group comprises the subfield having the weight added value of 64, the subfield having the weight added value of 32, the subfield having the weight added value of 16, two subfields of the weight added values of 8, the subfield having the weight added value of 4, and the subfield having the weight added value of 2, in order. A concept of the weight added value of the subfield and a concept of the idle period in one frame are illustrated in FIG. 13B.

Referring to FIG. 13B, two subfield groups, that is, the first and second subfield groups are comprised in one frame, and the idle period is comprised between the subfield groups. Attention should be paid to the triangle shape of the weight added values of the subfields comprised in each of the subfield groups. This means that the subfields are arranged in a sequence of decreasing the magnitude that represents the weight added value, that is, the gray level value in each subfield group.

The idle period having a predetermined length is further comprised between the first and second subfield groups.

A sum of the weight added values of the subfields arranged in one frame is 1+2+4+8+(8+8)+(16+16)+(32+32)+(64+64), that is, 255 in the same as FIG. 9A. As a result, the subfields having the weight added values of 1, 2, 4, 8, 16, 32, 64, and 128 are arranged in a reverse sequence depending on the magnitudes of the gray level values so that a total of the weight added values, that is, a total of the gray level values can embody the 256 gray levels such as the frame of FIG. 2. Further, the second subfield group for embodying the 121 gray levels and the first subfield group for embodying the 135 gray levels can be provided, thereby obtaining an effect of two frames for embodying the 121 and 135 gray levels. Accordingly, flicker is reduced. In the driving method using the subfield arrangement, in comparison with FIG. 9A, the subfield arrangement is in the reverse sequence and the remainder is substantially the same and therefore, its duplicate description will be omitted.

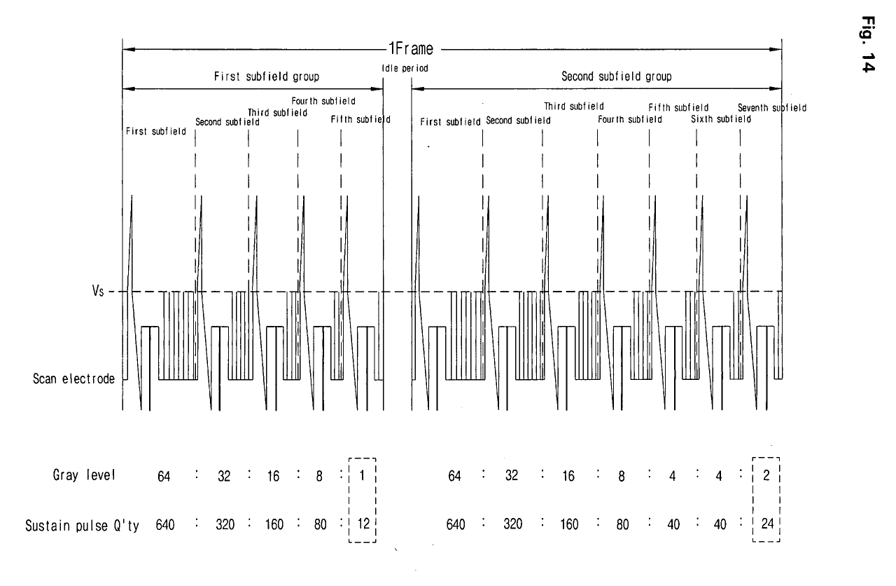

In a case where the subfields are arranged in the reverse sequence depending on the magnitudes of the gray level values in one subfield group in the driving method where one frame is divided into the plurality of subfield groups, the number per the unit gray level of the sustain pulses supplied in the sustain period at the low gray level subfield having the lower weight added value is more than at other subfields. An example of such a driving method will be described as in FIG. 14 below.

FIG. 14 illustrates an example of a driving waveform having the subfield arrangement sequence of FIGS. 13A and 13B.

As shown in FIG. 14, the arrangement sequence of the subfields in each subfield group is opposite to that of FIG. 10.

For example, in case where one frame is divided into two subfield groups, that is, the first subfield group and the second subfield group as in FIG. 14, the number (12) per the unit gray level of the sustain pulses supplied in the sustain period of the last subfield for embodying the lowest gray level due to the lowest weight added value in each subfield group, that is, the fifth subfield in the first subfield group and the seventh subfield in the second subfield group is more than the number (10) per the unit gray level of the sustain pulses of other subfields, that is, the first, second, third, and fourth subfields of the first subfield group and the first, second, third, fourth, fifth, and sixth subfields of the second subfield group.

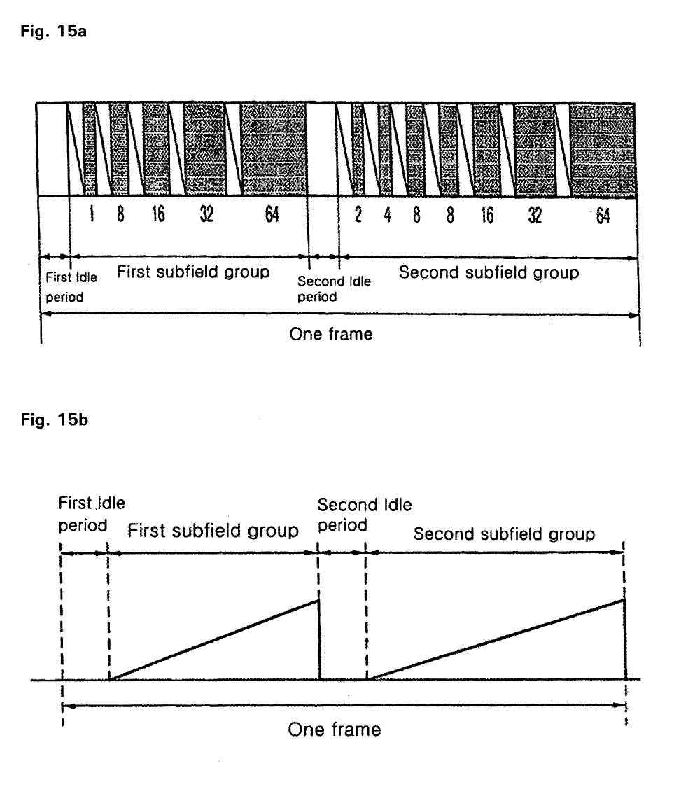

In the above description, one frame is divided into the plurality of subfield groups, and one idle period is comprised between the plurality of subfield groups. However, it is also possible to additionally comprise the idle period having a predetermined length not only between the subfield groups but also between the frames. Such a driving method will be described as in FIGS. 15A and 15B below.

FIGS. 15A and 15B illustrate another example of dividing one frame into the plurality of subfield groups.

Referring to FIGS. 15A and 15B, one idle period having a predetermined length is comprised between the first and second subfield groups in FIG. 9A whereas a first idle period having a predetermined length is comprised in front of the frame, and a second idle period having a predetermined length is comprised between the first and second subfield groups.

Referring to FIG. 15A, as in FIG. 9A, the subfields of one frame are divided into a plurality of groups, preferably, two subfield groups, that is, the first and second subfield groups, and are arranged in a sequence of increasing the magnitude of the weight added value, that is, the magnitude of the gray level value in each subfield group. In other words, the subfield having the lowest magnitude of the weight added value, that is, the gray level value is disposed at an initial position of each subfield group, and the subfield having the higher weights added value is disposed at a later position. For example, as in FIG. 15A, the first subfield group comprises the subfield having the weight added value, that is, the gray level value of 1, the subfield having the weight added value of 8, the subfield having the weight added value of 16, the subfield having the weight added value of 32, and the subfield having the weight added value of 64, in order. The second subfield group comprises the subfield having the weight added value, that is, the gray level value of 2, the subfield having the weight added value of 4, two subfields of the weight added values of 8, the subfield having the weight added value of 16, the subfield having the weight added value of 32, and the subfield having the weight added value of 64, in order.

As described above, the second idle period having a predetermined length is comprised between the above arrangement of subfield groups, and the first idle period having a predetermined length is comprised between the frames. The first and second idle periods can be different or the same in length. However, considering an effect of visual division between the subfield groups and an easiness of driving control, preferably, the first and second idle periods are the same length.

A visual effect for recognizing one frame as two frames by using the first idle period provided between the frames and the second idle period provided between the subfield groups is more enhanced. Accordingly, the generation of the flicker is reduced even more, thereby improving picture quality. The driving methods of FIGS. 15A and 15B are substantially the same as those of FIGS. 9A and 9B and therefore, their further duplicate descriptions will be omitted.

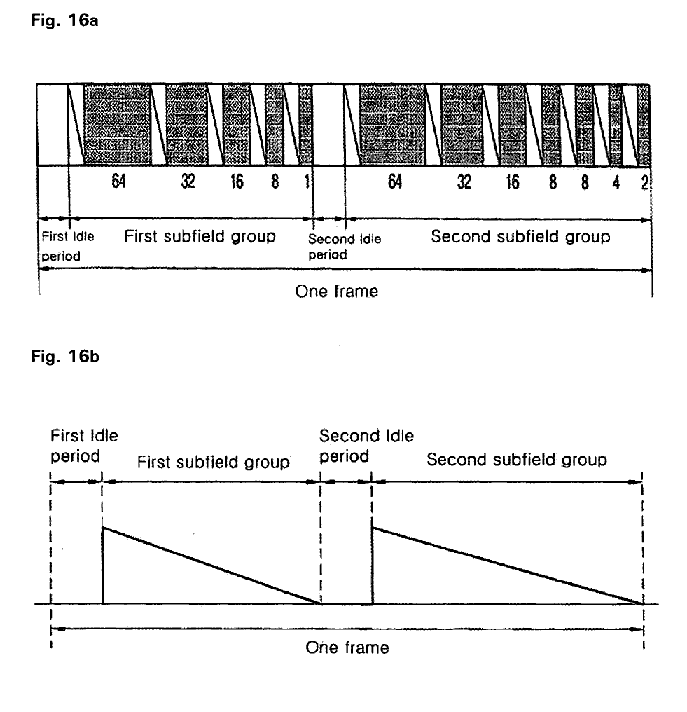

An example of the driving method where the idle periods are comprised between the subfield groups and between the frames, respectively, as in FIG. 15A, and the subfield arrangement is opposite to that of FIG. 15A will be described as in FIGS. 16A and 16B below.

FIGS. 16A and 16B illustrate still another example of dividing one frame into the plurality of subfield groups.

In comparison with FIGS. 15A and 15B where the subfields are arranged in a sequence of increasing magnitude of the gray level value in the first and second subfield groups, the subfield arrangement of the driving waveform of FIGS. 16A and 16B is just only in opposite to and is substantially the same in its content as that of the FIGS. 15A and 15B, and therefore its duplicate description will be omitted.

In the driving method of the plasma display panel according to the first embodiment of the present invention, one frame is divided into the plurality of subfield groups, and the number per unit gray level of the sustain pulses of the low gray level subfield in at least one subfield group is more than at other subfields. Unlike the first embodiment, it is possible to make the length of the sustain time, that is, the length of the pulse width of the sustain pulse per unit gray level of the low gray level subfield, to be longer than other subfields. Such a driving method will be described as in the following second embodiment of the present invention.

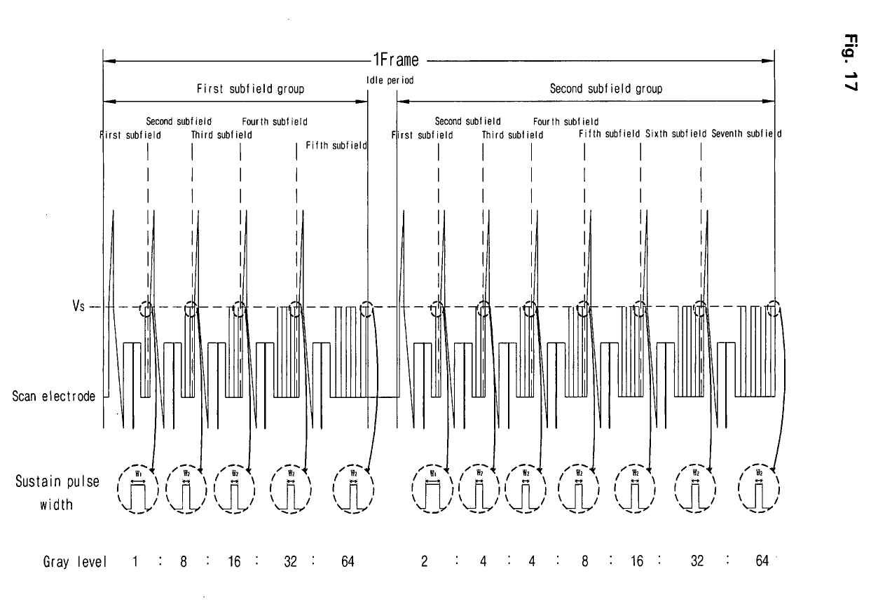

FIG. 17 illustrates the driving method of the plasma display panel according to the second embodiment of the present invention.

In the driving method of the plasma display panel according to the second embodiment of the present invention, one frame is divided into a plurality of subfield groups each having at least one subfield, and lengths of sustain times per a unit gray level of sustain pulses supplied in a sustain period of a low gray level subfield in at least one of the divided subfield groups are longer than in other subfields. As shown in FIGS. 9A and 9B, in one frame, the subfield is divided and arranged as first and second subfields.

The lengths of the sustain times per unit gray level of the sustain pulses means the time for sustaining the sustain voltages (Vs) of the sustain pulses for embodying one gray level. For example, assuming that 10 sustain pulses having sustain times of 1 μs of the sustain voltages (Vs) are applied to embody two gray levels in one subfield group, a total of the sustain times of the sustain pulses is 10 μs. In other words, the subfield has an average sustain time of 5 μs in order to embody a gray level of 1. A total sum of the sustain times of the sustain voltages (Vs) of the aforementioned whole sustain pulses compared with the gray level is called the lengths of the sustain times per the unit gray level of the sustain pulses.

An idle period having a predetermined length is comprised between the first and second subfields as in FIGS. 9A and 9B. In other words, one idle period is comprised between two subfield groups.

One frame is divided into the plurality of subfield groups, for example, into first and second subfield groups, and the length of the sustain time per the unit gray level of the sustain pulse supplied in the sustain period of the low gray level subfield having the low weight added value, that is, the low gray level in at least one of the divided subfield groups are controlled.

For example, in a case where one frame is divided into two subfield groups, that is, the first and second subfield groups as shown in FIG. 17, the lengths of the sustain times per unit gray level of the sustain pulses supplied in the sustain period at a first subfield for embodying the lowest gray level due to the lowest weight added value in each subfield group, that is, at a first subfield of the first subfield group and a second subfield of the second subfield group are longer than the lengths of the sustain times, that is, the lengths of the pulse widths per the unit gray level of the sustain pulses in the other subfields, that is, at second, third, fourth, and fifth subfields of the first subfield group and second, third, fourth, fifth, sixth, and seventh subfields of the second subfield group. In other words, if the length of the sustain time, that is, the length of the pulse width of the sustain pulse used to embody the gray level of 1 at the first subfield of the first subfield group is denoted by “W1”, the length of the sustain time, that is, the length of the pulse width of the sustain pulse used to embody the gray level of 1 in other subfields of the first subfield group is denoted by “W2”. “W1” has a larger value than the “W2”.

In FIG. 17, the lengths of the sustain times, that is, the lengths of the pulse widths per the unit gray level of the sustain pulses of the low gray level subfields are longer than in other subfields in all subfield groups of one frame, that is, in all of the first and second subfield groups. Unlike this, the lengths of the sustain times, that is, the lengths of the pulse widths per the unit gray level of the sustain pulses are also longer than at other subfields only in any selected one of the plurality of subfield groups, for example, only in any one of the first and second subfield groups.

FIG. 17 illustrates the lengths of the sustain times, that is, the pulse widths of the sustain pulses of one subfield are longer than the lengths of the sustain times of the sustain pulses of other subfields, but it is possible that only some of the sustain pulses of the low gray level subfield have longer sustain time lengths and remaining sustain pulses have shorter lengths than the sustain pulses of other subfields in one subfield group.

For example, it is assumed that the first and second subfields are comprised as the low gray level subfields having the lower weight added values in one subfield group. If the first subfield having the gray level value of 1 comprises two sustain pulses having a sustain time length of 10 and one sustain pulse having a sustain time length of 25, and the second subfield having a gray level value of 2 comprises six sustain pulses having a sustain time length of 12, the gray level of 1 is embodied at the first subfield by the sustain times of a total of 45 sustain pulses, and the gray level of 2 is embodied at the second subfield by the sustain times of a total of 72 sustain pulses. Accordingly, a total of the sustain time lengths of the sustain pulses for embodying one gray level is 45 at the first subfield, and a total of the sustain time lengths of the sustain pulses for embodying one gray level is 36 in the second subfield. In other words, the lengths of the sustain times per the unit gray level of the sustain pulses of the first subfield are longer than the sustain time lengths in second subfield. However the lengths of the sustain times of all sustain pulses of the first subfield are not absolutely longer than the lengths of the sustain times of all sustain pulses of the second subfield, but any one of the sustain pulses of the second subfield can have a longer sustain time length than the sustain pulses of the first subfield.

The reason why the lengths of the sustain times, that is, the pulse widths per the unit gray level of the sustain pulses supplied in the sustain period at the low gray level subfield are longer than in other subfields is to suppress flicker and stabilize the sustain discharge at the low gray level subfield where the address discharges are weak. The reason for lengthening the length of the sustain time of the sustain pulse to stabilize the sustain discharge at the low gray level subfield is the same as in the driving method of the plasma display panel according to the second embodiment of the present invention and therefore its duplicate description will be omitted.

Even in the driving method according to the second embodiment of the present invention, the low gray level subfield can be determined depending on the number of the sustain pulses supplied in the sustain period as in the first embodiment. For example, the low gray level subfield is a subfield having a number of sustain pulses that is 50% or less than tha largest total number of sustain pulses supplied in the sustain period within one frame.

A subfield having a number of sustain pulses that is 20% or less of the total number of the sustain pulses of one frame supplied is set as the low gray level subfield.

The plurality of low gray level subfields can also be set in a sequence where the sustain pulses are small in number, in one subfield group. For example, the subfield having the least number of the sustain pulses up to the fourth subfield in a sequence where the sustain pulses are small in number are set as the low gray level subfields. In other words, assuming that a total of seven subfields constitutes the second subfield group, as in FIG. 17, the first subfield having the lowest number of the sustain pulses, that is, the least gray level value to the second, third, and fourth subfields are set as the low gray level subfields. It is more preferable that the low gray level subfield is one subfield having the lowest gray level value in one subfield group.

As aforementioned, the lengths of the sustain times per the unit gray level of the sustain pulses of the low gray level subfield get to be longer than at other subfields.

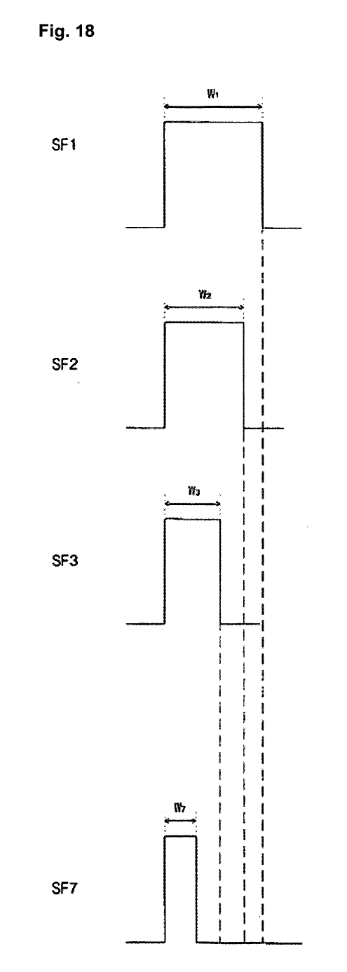

In a case where the plurality of low gray level subfields are comprised in one subfield group, the lengths of the sustain times per the unit gray level of the sustain pulses can be different even between the low gray level subfields. An example of such a driving waveform will be described as in FIG. 18 below.

FIG. 18 illustrates an example of a method of setting sustain time length of the sustain pulse of the low gray level subfield in the driving method of the plasma display panel according to the second embodiment of the present invention.

As shown in FIG. 18, in a case where one subfield group is comprised of seven subfields, and the first subfield having the lowest gray level value and the subsequent second and third subfields are set as the low gray level subfields in a sequence where the gray level value is small, the lengths of the sustain times per unit gray level of the sustain pulses supplied in the sustain period of the first, second, and third subfields being the low gray level subfields are different from one another and get to be longer than a length (W7) of a sustain time per the unit gray level of a sustain pulse of a remaining subfield, for example, a seventh subfield. For example, as in FIG. 18, assuming that the length of the sustain time per the unit gray level of the sustain pulse of the first subfield is denoted by “W1”, the length at the second subfield is denoted by “W2”, and the length at the third subfield is denoted by “W3”, a relation of W3<W2<W1 is obtained.

In a case where the low gray level subfields of one subfield group have the length of the sustain time per the unit gray level of the sustain pulses comprising at least one different sustain pulse, the length of the sustain time per the unit gray level of the sustain pulse depends on the magnitude of the gray level value of the corresponding subfield in the subfield group. For example, in a case where two low gray level subfields, that is, the first and second low gray level subfields are selected from the low gray level subfields of one subfield group, the length of the sustain time per the unit gray level of the sustain pulse of the first or second low gray level subfield having a lower gray level value is longer than the first or second low gray level subfield having a larger gray level value.

Even though the plurality of low gray level subfields is comprised in one subfield group, the lengths of the sustain pulses per the unit gray level supplied in the sustain period of the low gray level subfields can also be all the same. Describing a case of FIG. 18 as one example, the length (W1) of the sustain time per the unit gray level of the sustain pulse of the first subfield being the low gray level subfield, the length (W2) at the second subfield, and the length (W3) at the third subfield are different from one another, However, the lengths of the sustain times per the unit gray level of the sustain pulses of the first, second, and third subfields being the low gray level subfields of the first subfield group can also be the same.

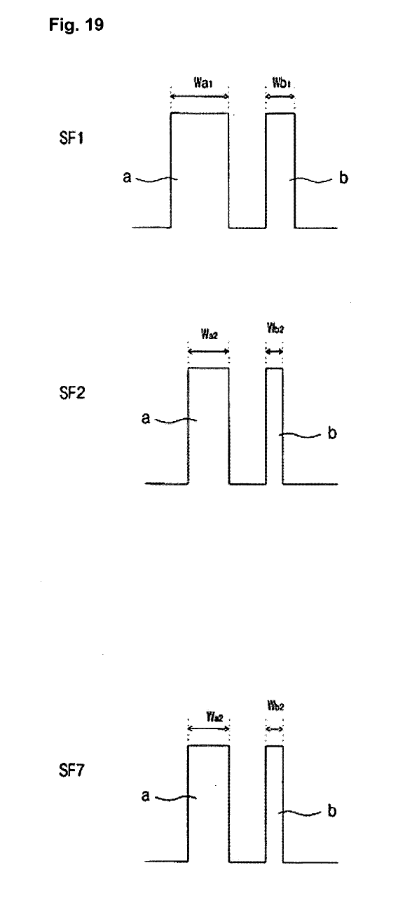

The length of the sustain time per the unit gray level of the sustain pulse can be set by controlling the lengths of the sustain times, that is, the pulse widths of all sustain pulses of one subfield, However, it is also possible to set the length of the sustain time per the unit gray level of the sustain pulse of a corresponding subfield by controlling the length of the sustain time, that is, the pulse width of a predetermined number of selected sustain pulses. Such a driving method will be described as in FIG. 19 below.

FIG. 19 illustrates another example of a setting method of the sustain time length of the sustain pulse of the low gray level subfield in the driving method of the plasma display panel according to the second embodiment of the present invention.

As shown in FIG. 19, the length of the sustain time, that is, the pulse width of at least any one of the sustain pulses applied in the sustain period at one subfield can be controlled, thereby controlling the length of the sustain time per the unit gray level of the sustain pulse at one subfield. For example, by increasing the length of the sustain time of any one of sustain pulses of the low gray level subfield in one subfield group, the length of the sustain time per the unit gray level of the sustain pulse of the low gray level subfield can get to be longer than the length of the sustain time of other sustain pulses.

For example, as in FIG. 19, in case where the length of the sustain time, that is, the pulse width of the first one (a) of the sustain pulses supplied in the sustain period of the first subfield is denoted by “Wa1” and the length of the sustain time, that is, the pulse width of the subsequent second sustain pulse (b) is denoted by “Wb1” less than the “Wa1”, and the length of the sustain time, that is, the pulse width of the first one (a) of the sustain pulses supplied in the sustain period of the second subfield is denoted by “Wa2” and the length of the sustain time, that is, the pulse width of the subsequent second sustain pulse (b) is denoted by “Wb2” less than the “Wa2”, a total length of the sustain time of the sustain pulse of the first subfield is (Wa1+Wb1) and a total length of the sustain time of the sustain pulse of the second subfield is (Wa2+Wb2). FIG. 19 illustrates the Wb1 longer than the Wb2, but even though the Wb1 and the Wb2 are the same in length, the length of the sustain time per the unit gray level of the sustain pulse of the first subfield gets to be longer than the length of the sustain time per the unit gray level of the sustain pulse of the second subfield since the Wa1 is longer than the Wa2. This is a case where the gray level value of the first subfield is less than the gray level of the second subfield.

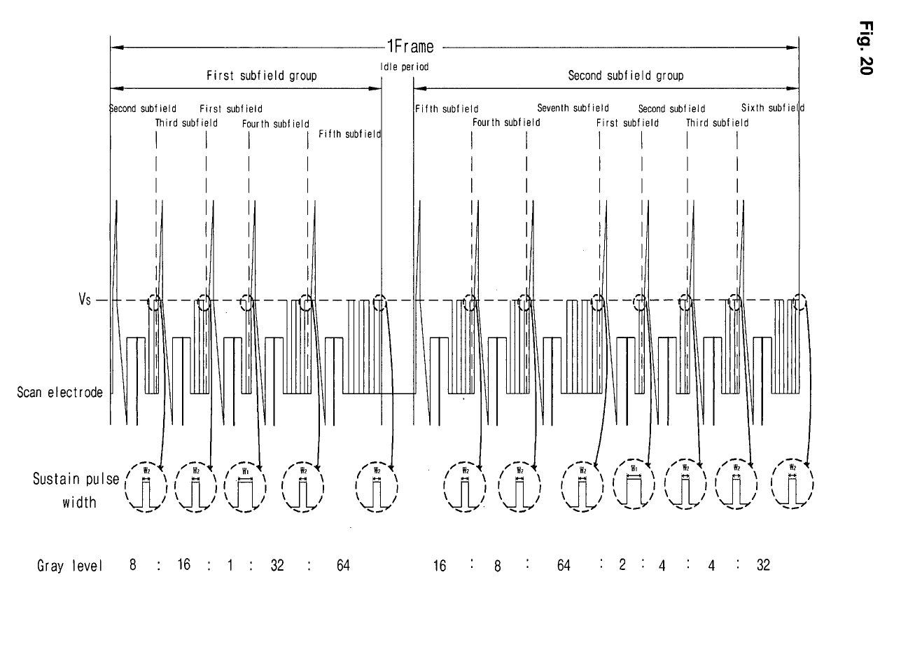

The above description is only an example where the subfields of one subfield group are regularly arranged in a sequence depending on the magnitude of the weight added value, that is, the magnitude of the gray level value, However, it is also possible to randomly arrange the subfields in one subfield group. An example of such a driving method will be described as in FIG. 20 below.

FIG. 20 illustrates the arrangement of the subfields in one subfield group in the driving method of the plasma display panel according to the second embodiment of the present invention.

As shown in FIG. 20, in at least one subfield group, the subfields are not regularly arranged in a sequence depending on the magnitude of the weight added value, that is, the magnitude of the gray level value, but are randomly arranged irrespective of the magnitude of the gray level value. Even in the subfield group having the irregular subfield arrangement, the length (W1) of the sustain time per the unit gray level of the sustain pulse supplied in the sustain period at a third numbered subfield being the low gray level subfield having the lower weight added value, that is, at the first subfield of the first subfield group is longer than the lengths (W2) of the sustain times per the unit gray level of the sustain pulses of other subfields, and the length (W1) of the sustain time per the unit gray level of the sustain pulse supplied in the sustain period at a fourth numbered subfield, that is, at the first subfield of even the second subfield group is longer than the lengths (W2) of the sustain times per the unit gray level of the sustain pulses of other subfields.

In comparison with FIG. 17 based on the assumption that the subfield arrangement is based on a sequence of first, second, third, fourth, and fifth subfields in the first subfield group, and a sequence of first, second, third, fourth, fifth, sixth, and seventh subfields in the second subfield group, the subfield arrangement of FIG. 20 is based on a sequence of the second, third, first, fourth, and fifth subfields in the first subfield group, and a sequence of fifth, fourth, seventh, first, second, third, and sixth subfields in the second subfield group. In FIG. 20, the subfields are randomly arranged irrespective of the magnitude of the weight added value, that is, the magnitude of the gray level value in one subfield group. However, the high gray level subfield having the higher weight added value, that is, the higher gray level value in one subfield group and the low gray level subfield having the lower weight added value, that is, the lower gray level value can be alternately arranged in one subfield group. The arrangement sequence of the subfields does not limit the present invention and, even though the subfield group has any subfield arrangement, It is most important that the length of the sustain time per the unit gray level of the sustain pulse supplied in the sustain period of the low gray level subfield among the subfields of the subfield group is longer than at other subfields.

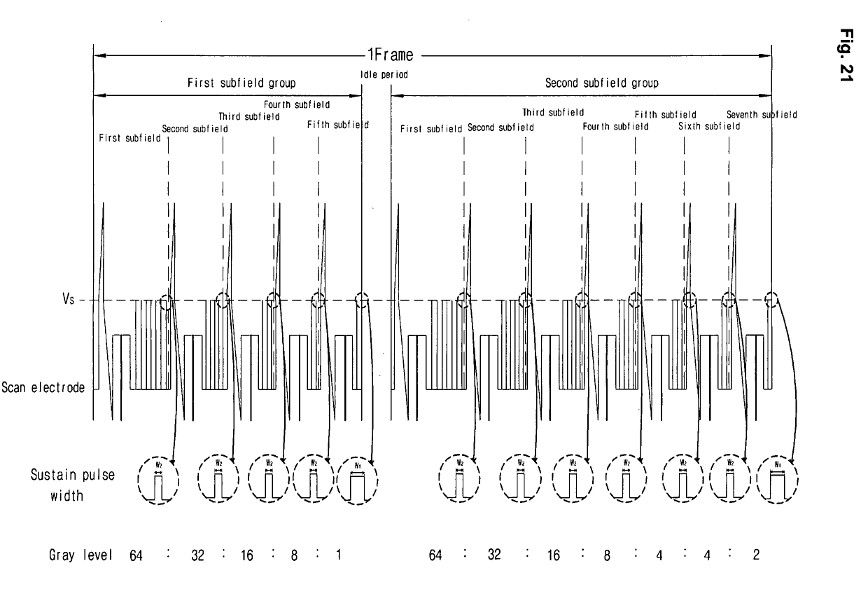

The description of the driving method according to the second embodiment of the present invention will be made on the basis of the subfield arrangement based on a sequence of increasing the weight added value, that is, the gray level value in one subfield group, However, as in FIGS. 13A and 13B, it is possible to arrange the subfields in a sequence of decreasing the gray level value, in at least one subfield group. Such a driving method will be described as in FIG. 21 below.

FIG. 21 illustrates another arrangement of the subfields within one subfield group in the driving method of the plasma display panel according to the second embodiment of the present invention.

As shown in FIG. 21, the subfield arrangement in the subfield group is in the reverse sequence in comparison with FIG. 17. Here, the idle period having a predetermined length is comprised between the first and second subfield groups.

In a case where the subfields are arranged in the reverse sequence depending on the magnitude of the gray level value of the subfields in one subfield group in the driving method where one frame is divided into the plurality of subfield groups as aforementioned, the length of the sustain time per the unit gray level of the sustain pulse supplied in the sustain period in the low gray level subfield having the lower weight added value is longer than at other subfields.

For example, in case where one frame is divided into two subfield groups, that is, the first subfield group and the second subfield group as in FIG. 21, the lengths of the sustain times per the unit gray level of the sustain pulses supplied in the sustain period at the last subfield for embodying the lowest gray level due to the lowest weight added value in each subfield group, that is, at the fifth subfield of the first subfield group and the seventh subfield of the second subfield group is longer than the lengths of the sustain times per the unit gray level of the sustain pulses at other subfields, that is, at the first, second, third, and fourth subfields of the first subfield group and the first, second, third, fourth, fifth, and sixth subfields of the second subfield group.

In such a driving method using the subfield arrangement, the subfield arrangement is in the reverse sequence and a remainder is substantially the same as that of FIG. 17 and therefore, its duplicate description will be omitted.

In the above description, one frame is divided into the plurality of subfield groups, and one idle period is comprised between the plurality of subfield groups. Unlike this, as in FIGS. 15A and 15B, the idle period having a predetermined length can be also additionally comprised not only between the subfield groups but also between the frames.

As in FIGS. 16A and 16B, the subfield arrangement is made in the reverse sequence to that of FIG. 15A in the subfield group, and the idle periods, that is, the first idle period and the second idle period can be also comprised between the subfield groups and between the frames, respectively, as in FIGS. 15A and 15B.

An example of the idle periods having predetermined lengths comprised between the frames and between the subfield groups, respectively, is in detail described in the aforementioned driving method and therefore, its duplicate description will be omitted.

The invention being thus described may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus displaying an image in a frame having a plurality of subfield groups, the plasma display apparatus comprising:
a plasma display panel comprising a scan electrode and a sustain electrode; and
a sustain pulse controller for setting a number of sustain pulses applied to the scan electrode or the sustain electrode per a unit gray level in sustain period of a lower gray level subfield of a subfield group to be greater than the number of sustain pulses of the other subfield in the frame.

2. The apparatus of claim 1, wherein the subfield group has at least two low gray level subfields and the sustain pulse controller sets the numbers of the sustain pulses per the unit gray level applied in sustain periods of the low gray level subfields of the subfield group to be all the same.

3. The apparatus of claim 1, wherein the subfield group has at least two low gray level subfields and the sustain pulse controller sets the numbers of the sustain pulses per the unit gray level applied in sustain periods of any one low gray level subfields of the subfield group to be different from other low gray level subfields.

4. The apparatus of claim 3, wherein the sustain pulse controller allows the number of the sustain pulses per the unit gray level supplied in the sustain period of a first low gray level subfield having a lower gray level value than a second low gray level subfield among two different low gray level subfields to be greater than the number of the sustain pulses per the unit gray level of the second low gray level subfield, in one subfield group.

5. The apparatus of any one of claims 1 to 4, wherein the low gray level subfields are comprised of a subfield having the lowest number of the sustain pulses up to a fourth subfield, in a sequence where the number of the sustain pulses supplied in the sustain period is small, in one subfield group.

6. The apparatus of claim 5, wherein the low gray level subfield is a subfield having the lowest number of the sustain pulses supplied in the sustain period, in one subfield group.

7. The apparatus of any one of claims 1 to 4, wherein the low gray level subfield is a subfield having a half or less of a total of the largest number of the sustain pulses supplied in the sustain period in one frame.

8. The apparatus of any one of claims 1 to 4, wherein the low gray level subfield is a subfield having 20% or less of a total number of the sustain pulses supplied in one frame.

9. The apparatus of claim 1, wherein the subfields are irregularly arranged in a sequence depending on a magnitude of a gray level value, in at least one subfield group.

10. The apparatus of claim 1, wherein an idle period having a predetermined length is provided between the frames, and the subfield groups of the frame are continued in the same frame.

11. The apparatus of claim 1, wherein a first idle period having a predetermined length is provided between the frames, and a second idle period having a predetermined length is additionally provided between the subfield groups in the same frame.

12. The apparatus of claim 11, wherein the first and second idle periods are the same in length.

13. The apparatus of claim 1, wherein the plurality of subfield groups has a plurality of subfields, respectively, and the subfields are arranged in a sequence of increasing the magnitude of the gray level value, in each of the plurality of subfield groups.

14. The apparatus of claim 1, wherein the plurality of subfield groups has a plurality of subfields, respectively, and the subfields of each of the plurality of subfield groups are arranged in a sequence of decreasing the magnitude of the gray level value.

15. The apparatus of claim 1, wherein the frame is divided into two subfield groups, and the two subfield groups have a plurality of subfields, respectively, and the subfields are arranged in a sequence depending on magnitudes of gray level values different from one another, in each of the two subfield groups.

16. The apparatus of claim 15, wherein the subfields are arranged in a sequence of increasing the magnitude of the gray level value, in any one of the two subfield groups.

17. The apparatus of claim 15, wherein the subfields are arranged in a sequence of decreasing the magnitude of the gray level value in any one of the two subfield groups.

18. The apparatus of claim 15, wherein the subfields are arranged in a sequence of decreasing the magnitude of the gray level value in any one of the two subfield groups, and the subfields are arranged in a sequence of increasing the magnitude of the gray level value in the other one of the two subfield groups.

19. A driving apparatus of a plasma display panel displaying an image in a frame having a plurality of subfield groups, the driving apparatus of a plasma display panel comprising:
a driver for applying sustain pluse to a scan electrode or a sustain electrode; and
a sustain pulse controller for setting a number of sustain pulses applied to the scan electrode or the sustain electrode per a unit gray level in sustain period of a lower gray level subfield of a subfield group to be greater than the number of sustain pulses of the other subfield in the frame.

20. A plasma display panel displaying an image in a frame having a plurality of subfield groups, the plasma display panel comprising:
a scan electrode and a sustain electrode,
wherein a number of sustain pulses applied to the scan electrode or the sustain electrode per a unit gray level in sustain period of a lower gray level subfield of a subfield group is greater than the number of sustain pulses of the other subfield in the frame.

21. A method of driving a plasma display apparatus displaying an image in a frame having a plurality of subfield groups, the method comprising:
setting a number of sustain pulses applied to the scan electrode or the sustain electrode per a unit gray level in sustain period of a lower gray level subfield of a subfield group to be greater than the number of sustain pulses of the other subfield in the frame.

22. A plasma display apparatus displaying an image in a frame having a plurality of subfield groups, the plasma display apparatus comprising:
a plasma display panel comprising a scan electrode and a sustain electrode; and
a sustain pulse controller for setting a width of sustain pulses applied to the scan electrode or the sustain electrode per a unit gray level in sustain period of a lower gray level subfield of a subfield group to be greater than the width of sustain pulses of the other subfield in the frame.

23. The apparatus of claim 22, wherein the subfield group has at least two low gray level subfields and the sustain pulse controller sets the width of the sustain pulses per the unit gray level applied in sustain periods of the low gray level subfields of the subfield group to be all the same.

24. The apparatus of claim 22, wherein the subfield group has at least two low gray level subfields and the sustain pulse controller sets the width of the sustain pulses per the unit gray level applied in sustain periods of any one low gray level subfields of the subfield group to be different from other low gray level subfields.

25. The apparatus of claim 24, wherein the sustain pulse controller allows the length of the sustain time of the sustain pulse per the unit gray level supplied in the sustain period of a first low gray level subfield having a smaller gray level value than a second low gray level subfield among two different low gray level subfields to be greater than the length of the sustain time of the sustain pulse per the unit gray level of the second low gray level subfield, in one subfield group.

26. The apparatus of any one of claims 22 to 25, wherein the low gray level subfields are comprised of a subfield having the least number of the sustain pulses up to a fourth subfield, in a sequence where the number of the sustain pulses supplied in the sustain period is small, in one subfield group.

27. The apparatus of claim 26, wherein the low gray level subfield is a subfield having the least number of the sustain pulses supplied in the sustain period, in one subfield group.

28. The apparatus of any one of claims 22 to 25, wherein the low gray level subfield is a subfield having a half or less of a total of the most number of the sustain pulses supplied in the sustain period, in one frame.

29. The apparatus of any one of claims 22 to 25, wherein the low gray level subfield is a subfield having 20% or less of a total number of the sustain pulses supplied in one frame.

30. The apparatus of claim 22, wherein the subfields are irregularly arranged in a sequence depending on a magnitude of a gray level value, in at least one subfield group.

31. The apparatus of claim 22, wherein an idle period having a predetermined length is provided between the frames, and the subfield groups of the frame are continued in the same frame.

32. The apparatus of claim 22, wherein a first idle period having a predetermined length is provided between the frames, and a second idle period having a predetermined length is additionally provided between the subfield groups in the same frame.

33. The apparatus of claim 32, wherein the first and second idle periods are the same in length.

34. The apparatus of claim 22, wherein the plurality of subfield groups has a plurality of subfields, respectively, and the subfields are arranged in a sequence of increasing the magnitude of the gray level value, in each of the plurality of subfield groups.

35. The apparatus of claim 22, wherein the plurality of subfield groups has a plurality of subfields, respectively, and the subfields are arranged in a sequence of decreasing the magnitude of the gray level value, in each of the plurality of subfield groups.

36. The apparatus of claim 22, wherein the frame is divided into two subfield groups, and the two subfield groups have a plurality of subfields, respectively, and the subfields are arranged in a sequence depending on magnitudes of gray level values different from one another, in each of the two subfield groups.

37. The apparatus of claim 36, wherein the subfields are arranged in a sequence of increasing the magnitude of the gray level value, in any one of the two subfield groups.

38. The apparatus of claim 36, wherein the subfields are arranged in a sequence of decreasing the magnitude of the gray level value, in any one of the two subfield groups.

39. The apparatus of claim 36, wherein the subfields are arranged in a sequence of decreasing the magnitude of the gray level value in any one of the two subfield groups, and the subfields are arranged in a sequence of increasing the magnitude of the gray level value in the other one of the two subfield groups.

40. A driving apparatus of a plasma display panel displaying an image in a frame having a plurality of subfield groups, the driving apparatus of a plasma display panel comprising:
a driver for applying sustain pluse to a scan electrode or a sustain electrode; and
a sustain pulse controller for setting a width of sustain pulses applied to the scan electrode or the sustain electrode per a unit gray level in sustain period of a lower gray level subfield of a subfield group to be greater than the width of sustain pulses of the other subfield in the frame.

41. A plasma display panel displaying an image in a frame having a plurality of subfield groups, the plasma display panel comprising:
a scan electrode and a sustain electrode,
wherein a width of sustain pulses applied to the scan electrode or the sustain electrode per a unit gray level in sustain period of a lower gray level subfield of a subfield group is greater than the width of sustain pulses of the other subfield in the frame.

42. A method of driving a plasma display apparatus displaying an image in a frame having a plurality of subfield groups, the method comprising:
setting a width of sustain pulses applied to the scan electrode or the sustain electrode per a unit gray level in sustain period of a lower gray level subfield of a subfield group to be greater than the width of sustain pulses of the other subfield in the frame.
